(19) United States
(12) Patent Application Publication
(10) Pub. No.: US 2012/0199247 A1
(43) Pub. Date: Aug. 9, 2012

(54) VENEER PEELING APPARATUS

(75) Inventor: Pekka Runonen, Ventaa (FI)

(73) Assignee: Raute Oyj

(21) Appl. No.: 13/368,546

(22) Filed: Feb. 8, 2012

(30) Foreign Application Priority Data
Feb. 9, 2011 (FI) 20115122

(51) Int. Cl. B27L 5/02

(52) U.S. Cl. 144/213

(57) ABSTRACT

The invention relates to a peeling station with means for rounding a block by peeling and means for producing veneers from the block by peeling The peeling station comprises a frame assembly provided with a rounding segment having first roller elements for accommodating and centering as well as rotating a block and a first knife element for peeling the block to become substantially circular in cross-section during its rotating motion; an interim storage segment for accommodating a rounded block; and a veneer peeling segment having second roller elements for accommodating and rotating the rounded block coming from the interim storage and a second knife element for peeling veneers from a block during its rotating motion.

### CROSS-REFERENCE TO RELATED APPLICATIONS

This application claims priority from and the benefit under 35 U.S.C. §119 of Finnish Patent Application No. 20115122, filed Feb. 9, 2011, in the Finnish Patent Office, which is hereby incorporated herein by reference in its entirety.

### BACKGROUND OF THE DISCLOSURE

1. Field of the Disclosure

The present invention relates to a peeling station with means for rounding a block by peeling and means for producing veneers from the block by peeling.

2. Description of Related Art

The prior art describes various rounding lathes for processing wood blocks in an effort to remove the protruding spots of their outer circumference and to make blocks as circular as possible in cross-section. One such prior known rounding lathe is disclosed in U.S. Pat. No. 4,554,958, wherein the rounding lathe is constructed as a spindleless lathe. It discloses two fixed upper rollers mounted on a common shaft for synchronized rotation. Below each upper roller is provided two movable rollers adapted to rotate in synchronism with the fixed rollers.

There are previously known spindleless veneer lathes in the prior art, such as for example a veneer lathe described in U.S. Pat. No. 4,781,229. It features a fixed roller and two movable rollers adapted to be movable along a first and a second plane. This solution enables the angle between a lathe knife and a block to be controlled continuously.

The rounding lathe and the veneer lathe are typically implemented as separate pieces of equipment usually with an interim storage for rounded blocks therebetween.

### SUMMARY OF THE DISCLOSURE

An objective of the present invention is to provide an improved peeling station with a capability of effectively integrating properties of a rounding lathe and a veneer lathe. In order to attain this objective, a peeling station of the invention is characterized in that the peeling station comprises a frame assembly provided with a rounding segment having first roller elements for accommodating and centering as well as rotating a block and a first knife element for peeling the block to become substantially circular in cross-section during its rotating motion; an interim storage segment for accommodating a rounded block; and a veneer peeling segment having second roller elements for accommodating and rotating the rounded block coming from the interim storage and a second knife element for peeling veneers from a block during its rotating motion.

The solution according to the invention comprises a single frame assembly, having in an effective manner integrated therein a rounding segment and a veneer peeling segment, between which is an interim storage for the rounded block. The rounding segment is provided with means for bringing the first roller elements in a mechanically positively driven manner to center a block, and with auxiliary spindles capable of being set against the ends of a block after centering the block for securing the block in its centered position. This is an effective way of ensuring the retainment of a block in its centered position during a rounding process. The roller elements are adapted to be released from positively driven mechanical operation once the auxiliary spindles have been set in position, and provided with independent suspension such that, after being released from positively driven operation, said rollers are in a spring-loaded contact against the block's outer surface. The use of auxiliary spindles provides a relatively simple roller configuration, wherein one and the same set of rollers first handles mechanically the centering of a block and, once the auxiliary spindles have been attached, the rollers are released from positively driven mechanical operation, after which the block rotation is carried out by said auxiliary spindles.

The apparatus is further provided with measuring instruments for measuring the diameter of a block on its way out of the rounding segment, and with means for feeding the measurement data to control means for the veneer peeling segment's roller elements. Thereby, the veneer peeling segment can be preset for a condition ready to receive the incoming block for a higher-speed operation of the veneer peeling segment.

The apparatus according to the invention is capable of providing a high capacity at low working speeds by virtue of concurrently occurring rounding and veneer peeling processes.

The apparatus according to the invention is preferably constructed as a compact portable unit which can be transported to various work sites, such as e.g. directly to a logging site. The apparatus can be in a mounted position e.g. on top of a carriage transported by a truck.

### BRIEF DESCRIPTION OF THE SEVERAL VIEWS OF THE DRAWING(S)

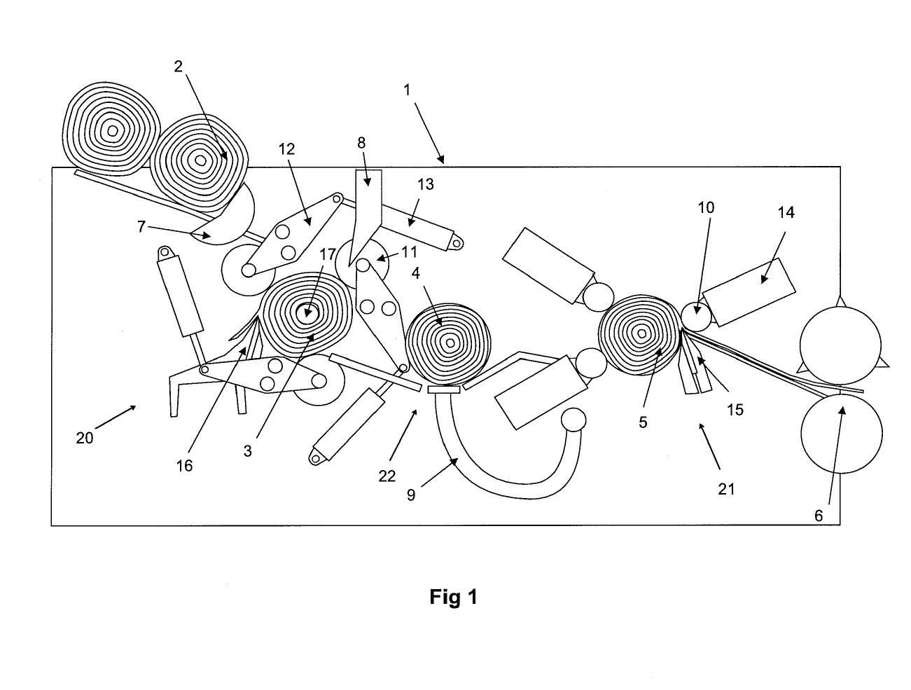

The invention will now be described more closely with reference to the accompanying drawings, the sole FIG. 1 of which shows one preferred embodiment of the invention in a schematic view of principle.

### DETAILED DESCRIPTION OF THE DISCLOSURE

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

A veneer peeling station 1 shown in FIG. 1 comprises a rounding segment 20 provided with a dispenser 7 for incoming blocks 2 and with a detent 8 for the dispenser. The rounding segment has rounding rollers 11 linked by way of a bracket member 12 to an actuator 13, e.g. to a pneumatic cylinder. The rounding rollers are capable of being coupled mechanically with each other, e.g. by means of a centering wheel (not shown) provided with suitable guide slots (evolvent curves), by placing e.g. the protruding ends of the rounding rollers' axles in said guide slots and by turning the centering wheel so as to have the roller positively driven to a substantially equal distance from the axial center line of the block. A block presently in the rounding segment is indicated by reference numeral 3. After centering, the block ends are grabbed by auxiliary spindles 17, followed by releasing the rounding rollers 11 from positive drive for bringing the same in an independently spring-loaded manner against a surface of the block 3. Each rounding roller is preferably provided with a freewheel clutch. What is accomplished by this is that, at the initial stage of a rounding process, the rollers furthest away from the center of a block are driving the block rotationally while the closer ones are rotating freely. During the rotating motion of a block, a knife mounted on a knife holder 16 removes irregularities of the block's outer circumference as well as makes the block sufficiently circular for the actual lathe work. The rounding segment is preferably provided with measuring instruments (not shown) capable of detecting a diameter of the block 3 on its way out of the rounding segment. In practice, the block diameter data is obtained as knife holder beam location data at the end of rounding and this diameter data is handed over to control means of the veneer peeling segment's roller elements 10. Thereby, the veneer peeling segment can be preset for a condition ready to receive the incoming block for a higher-speed operation of the veneer peeling segment. This veneer peeling segment 21 is accommodated in the same frame assembly as the rounding segment 20 and includes roller elements 10, along with their actuators 14, possibly comprising e.g. pneumatic cylinders, for rotationally driving a block 5. In addition, the veneer peeling segment has its own knife holder 15 along with its veneer peeling knife In the apparatus according to the invention, downstream of the veneer peeling segment is preferably located a veneer sheet cutter 6. Moreover, between the rounding segment and the veneer peeling segment is provided an interim storage 22 for rounded blocks 4. The block 5 is conveyed from the interim storage into the veneer peeling segment e.g. by means of a swivel arm 9. In connection with the interim storage 22 are preferably provided e.g. sawing or cutting members for calibrating the ends of the rounded block 4 to a desired dimension, i.e. for calibrating the length of a block.

The above-described embodiment has been illustrated in a highly schematic manner for making essential features of the invention understandable, nor does it include all of the elements necessary for operation of the apparatus and readily appreciated by a person skilled in the art, such elements being e.g. drive units for the rollers 11, 10, which may comprise e.g. a gear motor or a chain drive, or e.g. feeding elements for supplying blocks to the apparatus or conveying elements for carrying the cut veneer sheets away from the apparatus for further processing.

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims Although specific terms are employed herein, they are used in a generic and descriptive sense only and not for purposes of limitation.

1. A peeling station provided with means for rounding a block by peeling and means of producing veneers from the block by peeling, wherein the peeling station comprises a frame assembly provided with a rounding segment having first roller elements for accommodating and centering as well as rotating a block and a first knife element for peeling the block, such that the block becomes substantially circular in cross-section during rotating motion thereof; an interim storage segment for accommodating a rounded block; and a veneer peeling segment having second roller elements for accommodating and rotating the rounded block coming from the interim storage and a second knife element for peeling veneers from the rounded block during rotating motion thereof.

2. A peeling station as set forth in claim 1, wherein the rounding segment is provided with means for bringing the first roller elements in a mechanically positively driven manner to center the block; that the rounding segment has auxiliary spindles capable of being set against the ends of the block after centering the block for securing the block in its centered position; that the first roller elements are adapted to be released from positively driven mechanical operation once the auxiliary spindles have been set in position; and that the roller elements are provided with independent suspension such that, after being released from positively driven operation, said rollers are in a spring-loaded contact against an outer surface of the block.

3. A peeling station as set forth in claim 1, wherein the frame assembly is further provided with a cutter member downstream of the veneer peeling segment for cutting a veneer coming from the veneer peeling segment into veneer sheets.

4. A peeling station as set forth in claim 1, wherein the interim storage includes associated elements for calibrating the ends of the rounded block to a desired dimension.

5. A peeling station as set forth in claim 1, wherein the rounding segment includes associated measuring instruments for measuring a diameter of the block on its way out of the rounding segment, and means for feeding the measurement data to control means of the roller elements of the veneer peeling segment.

6. A peeling station as set forth in claim 1, wherein the peeling station is configured as a compact portable unit capable of being transported to various work sites.
